(19) United States
(12) Patent Application Publication
(10) Pub. No.: US 2023/0396835 A1
(43) Pub. Date: Dec. 7, 2023

(54) ADAPTIVE PACKET RETRANSMISSION WITH OPTIMIZED DELAY FOR REAL TIME COMMUNICATIONS

(71) Applicant: Apple Inc., Cupertino, CA (US)

(72) Inventors: Erik Vladimir Ortega Gonzales, Cupertino, CA (US); Maxwell J. Hawkins, Pittsburgh, PA (US); Ming Jin, Saratoga, CA (US); Chieh Lu, San Jose, CA (US); Ahmad M. Kholaif, Santa Clara, CA (US); Ashwin Ramesh, San Jose, CA (US); Christopher M. Garrido, Santa Clara, CA (US); Hsien-Po Shiang, Mountain View, CA (US); Karthick Santhanam, Campbell, CA (US); Luciano M. Verger, San Jose, CA (US); Jose A. Lozano Hinojosa, Santa Clara, CA (US); David L. Biderman, Los Gatos, CA (US)

(21) Appl. No.: 18/297,804

(22) Filed: Apr. 10, 2023

Related U.S. Application Data
(60) Provisional application No. 63/365,851, filed on Jun. 3, 2022.

(51) Int. Cl. H04N 21/44; H04L 49/9047; H04L 1/08; H04L 47/34; H04L 65/75; H04N 21/437; H04N 21/231; H04N 21/24

(52) U.S. Cl. CPC H04N 21/44004; H04L 49/9047; H04L 1/08; H04L 47/34; H04L 65/75; H04N 21/437; H04N 21/23106; H04N 21/2407

(57) ABSTRACT

A method and apparatus of a device that manages a video stream is described. In an exemplary embodiment, the device receives a plurality of packets for a video stream from a transmitting device via a server. The device may additionally store a first packet of the plurality of packets in a first buffer when the first packet is on-time and store a second packet of the plurality of packets in a second buffer when the second packet is late. The device may also further forward a frame from the second buffer to the first buffer when frame is complete.

This application claims the benefit of U.S. Provisional Patent Application No. 63/365,851 filed Jun. 3, 2022, which is incorporated herein by reference.

### FIELD OF INVENTION

This invention relates generally to real-time communications and more particularly to enhancing an adaptability for the real-time communications based on events and/or metrics from network interfaces of a device.

### BACKGROUND OF THE INVENTION

Packet retransmission is a technique to recover from packet loss. It consists of data receivers requesting missing data packets to transmitters to be resent via a negative acknowledgement.

### SUMMARY OF THE DESCRIPTION

A method and apparatus of a device that manages a video stream is described. In an exemplary embodiment, the device receives a plurality of packets for a video stream from a transmitting device via a server. The device may additionally store a first packet of the plurality of packets in a first buffer when the first packet is on-time and store a second packet of the plurality of packets in a second buffer when the second packet is late. The device may also further forward a frame from the second buffer to the first buffer when frame is complete.

In a further embodiment, a method and apparatus of a device that determines when to request of a retransmission of missing packet. In one embodiment, a device determines that the packet of a plurality of packets in a video stream is missing. In addition, the device further determines an aggressiveness factor for requesting a retransmission of the missing packet, the aggressiveness factor determined using a network statistic. Furthermore, the device may request a retransmission of the missing packet using a comparison of a time since last retransmission request and the aggressiveness factor.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 is an illustration of one embodiment of a system that performs a video telephony call.

FIG. 2 is an illustration of one embodiment of a system of server retransmitting a lost packet.

FIG. 3 is an illustration of one embodiment of a system of devices collecting statistics with a server.

FIG. 4 is an illustration of one embodiment of a process for adaptive retransmission for optimal delay.

FIG. 5 is an illustration of one embodiment of a missing packet timeline leading to video freeze.

FIG. 6 is a flow diagram of one embodiment of a process that manages packet retransmission for a video stream.

FIG. 7 is an illustration of one embodiment of a missing packet timeline leading to a shortened video freeze.

FIG. 8 is a flow diagram of one embodiment of a process that manages packet retransmission for a video stream and reduces the video freeze.

FIG. 9 is an illustration of one embodiment of a plot of a frame delay for a sustained delay versus an optimized delay.

FIG. 10 is an illustration of one embodiment of a system of multiple retransmissions of a lost packet.

FIG. 11 is a flow diagram of one embodiment of a process that determines an aggressiveness factor for packet retransmission.

FIG. 12 is an illustration of one embodiment of a plot of a time to repeat request versus packet loss for an adaptive aggressiveness and a fixed aggressiveness.

FIG. 13 is a flow diagram of one embodiment of a process that determines whether a retransmission request can be sent.

FIG. 14 illustrates one example of a typical computer system, which may be used in conjunction with the embodiments described herein.

FIG. 15 shows an example of a data processing system, which may be used with one embodiment of the present invention.

### DETAILED DESCRIPTION

A method and apparatus of a device that manages a video stream is described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that manages a video stream is described. In one embodiment, packet retransmission is a technique to recover from packet loss. In this embodiment, packet retransmission includes of data receivers requesting missing data packets to transmitters to be resent via a negative acknowledgement. In one embodiment, an architectural solution to retransmit the packets requested by video receivers is described, where the video receivers are serviced by the quick relay server. This solution helps deliver video playout with optimized latency, controlled bandwidth and adaptive aggressiveness. Server-based retransmission is more efficient than end-to-end retransmission to mitigate downlink packet loss since the time to fulfill a retransmission is on average two times faster. This solution relies on a fast and precise feedback mechanism between the server and the clients.

In one embodiment, a video receiver stores a late arriving packet in an incomplete frame buffer. If the packet completes the incomplete frame in the incomplete frame buffer, the completed frame is copied to a regular frame buffer. When the time is to play the frame(s) in the regular frame buffer, the frame is decoded and played.

In another embodiment, the video receiving device can change an aggressiveness on requesting a retransmission for a packet that is lost multiple times. In this embodiment, the video receiving device periodically determines network statistics, such as round trip time between the video receiving device and the server, packet loss level, fulfillment ratio, and/or other statistics. With these statistics, the device can compute an aggressiveness factor for how aggressive the device requests a retransmission on a packet that is lost multiple times. The device further can compare a time since last request for the missing packet with the aggressiveness factor to determine whether to request a retransmission.

In a further embodiment, the device can further determine whether to throttle retransmission requests, so as to limit the number of retransmission requests and to not add too much overhead to the network. In this embodiment, when preparing for a retransmission requests, the device checks to see if the retransmission request is within a long-term budget and/or a short-term budget. If this retransmission request is within these two budgets, the device send the retransmission request.

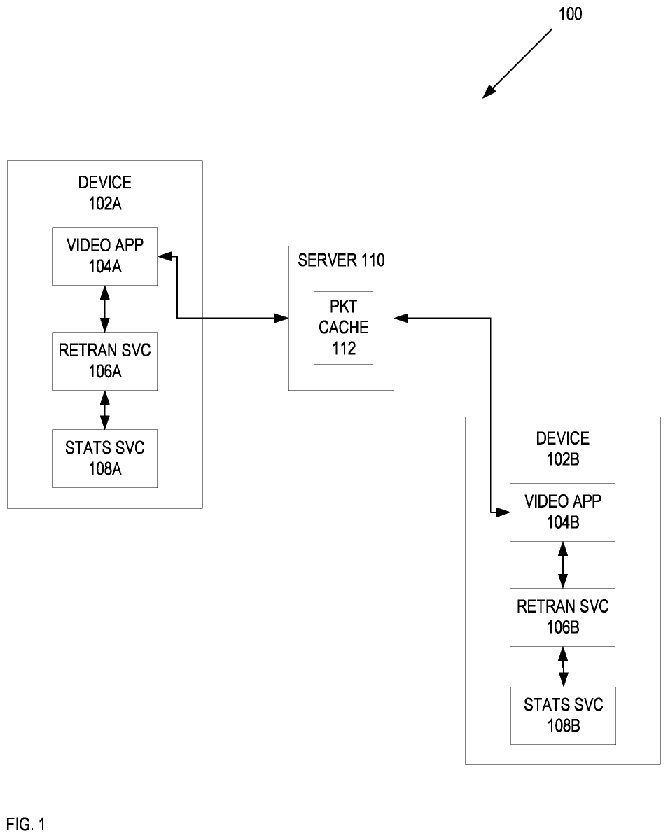

FIG. 1 is an illustration of one embodiment of a system 100 that performs a video telephony call. In FIG. 1, the system 100 includes devices 102A-B coupled with a server 106 in a network (not illustrated). In one embodiment, each of the devices 106A-B can be any type of device that can support media streaming (e. g., smartphone, laptop, personal computer, server, tablet, wearable, vehicle component, and/or any type of device that can process instructions of an application). In addition, the device is 102A-B and server are coupled through a network (not illustrated) can be any type of network that supports media streaming (e.g. Wi-Fi, Cellular, Bluetooth, Ethernet, another type of network, and/or a combination therein).

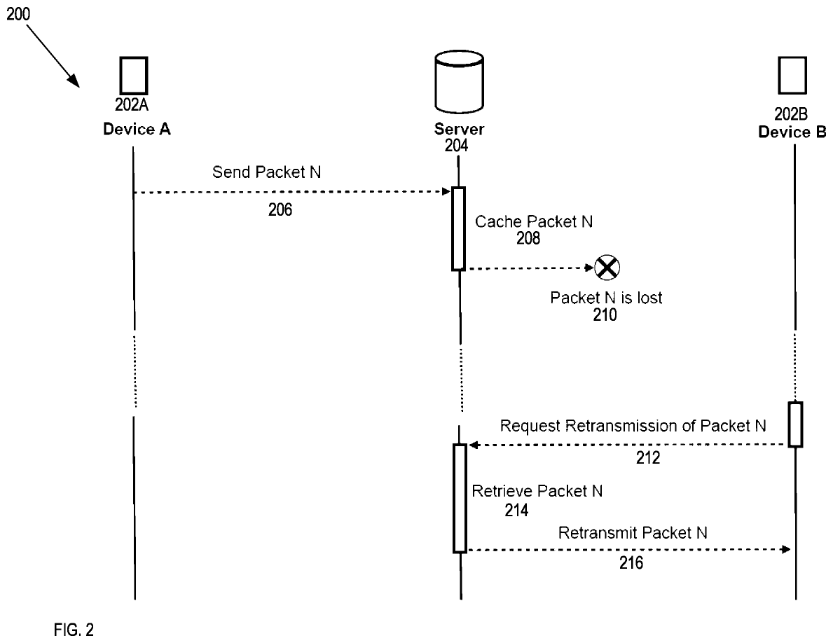

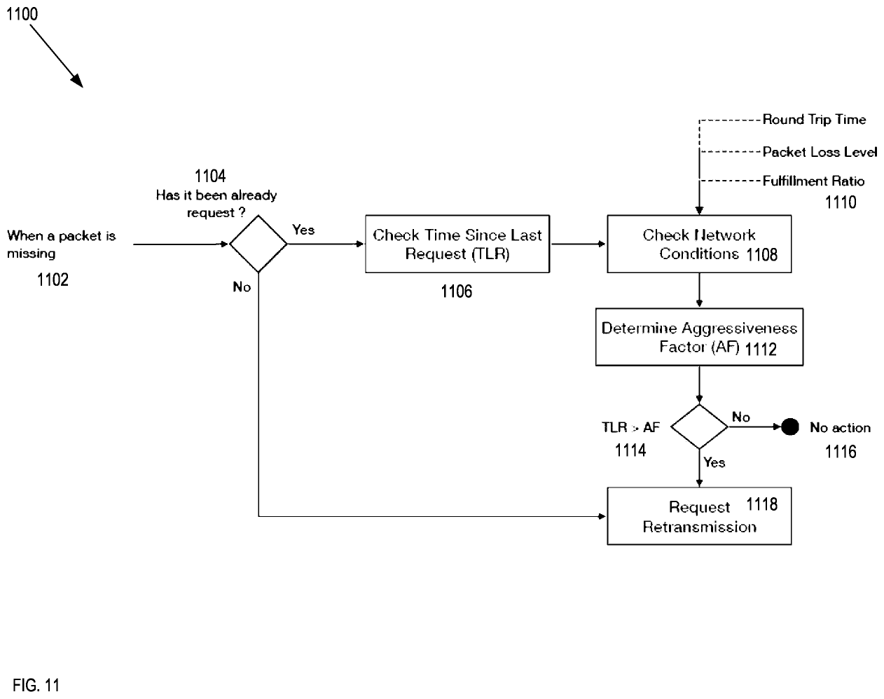

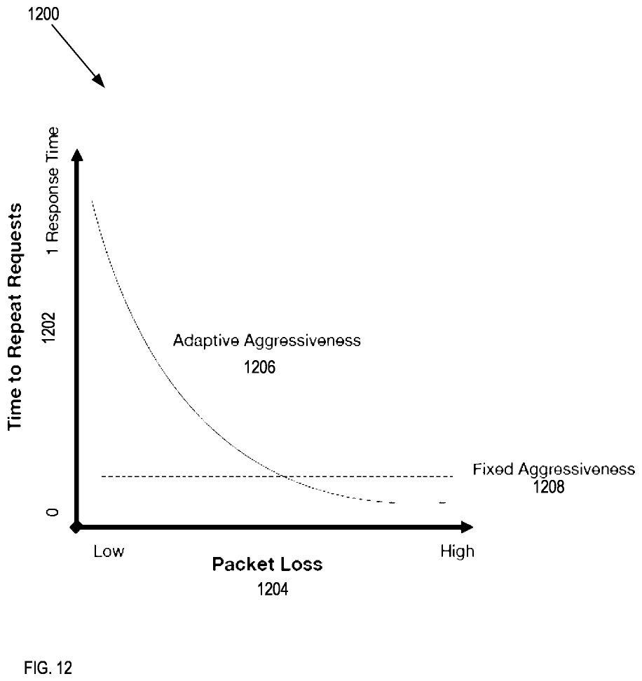

Each of the devices 102A-N can include a video application 104A-B is a video telephony can be used for two-way or multipoint reception and transmission of audio and video signals by people in different locations for real time communication. Alternatively, video application 104A-B can be another type of video application that requests and receives a video stream. In one embodiment, each video stream sent to one or more of the devices 102A-B can periodically lose one or more packets that are part of the video stream. In one embodiment, the video stream can be any type of packet based video stream (e.g., H.264, MPEG-4, and/or other types of packet-based video streams). Without that packet the playback of the video stream can be interrupted or frozen. The device 102A-B can request a retransmission of the packet when the device 102A-B detects that the packet has not arrived as part of the video stream. In this embodiment, each of the devices 102A-B includes a retransmission service 106A-B that requests a retransmission of a lost packet. In one embodiment, the retransmission service 106A-B requests the retransmission of the lost packet from the server 110 instead of the source of the video stream because, in this embodiment, the server 110 caches the packet in a packet cache 112. By caching the packet in the packet cache, a recovery of a lost packet is improved because server-based retransmission is more efficient than end-to-end retransmission to mitigate downlink packet loss since the time to fulfill a retransmission is on average two times faster. Packet retransmission is further described in FIGS. 2 and 5-8 below. In addition, the devices 102A-B includes a statistics service 108A-B that is used to gather statistics. In one embodiment, the gathered statistics is used by each of the devices 102A-B to determine when to request retransmission. In this embodiment, the gathered statistics can be used to determine an aggressiveness factor that can be used on when to request a retransmission. Determining an aggressiveness factor is further described in FIGS. 11-12 below.

FIG. 2 is an illustration of one embodiment of a system 200 of server retransmitting a lost packet. In FIG. 2, the system 200 includes devices A & B (202A-B), each coupled to the server 204. In one embodiment, device A (202A) sends packet N (206) to the server 204, where the server 204 caches packet N (208), where packet N is subsequently lost (210). In this embodiment, device B (202B) detects that packet N is lost. In one embodiment, device B (202B) detects that packet N is lost. In the embodiment, device B (202B) detects that the packet is lost because the packet does not arrive within a time period. In response to the detection that the packet N is lost, device B (202B) requests the retransmission of packet N (212). The server 204 retrieves the packet N (214) and retransmits packet N (216) to device B.

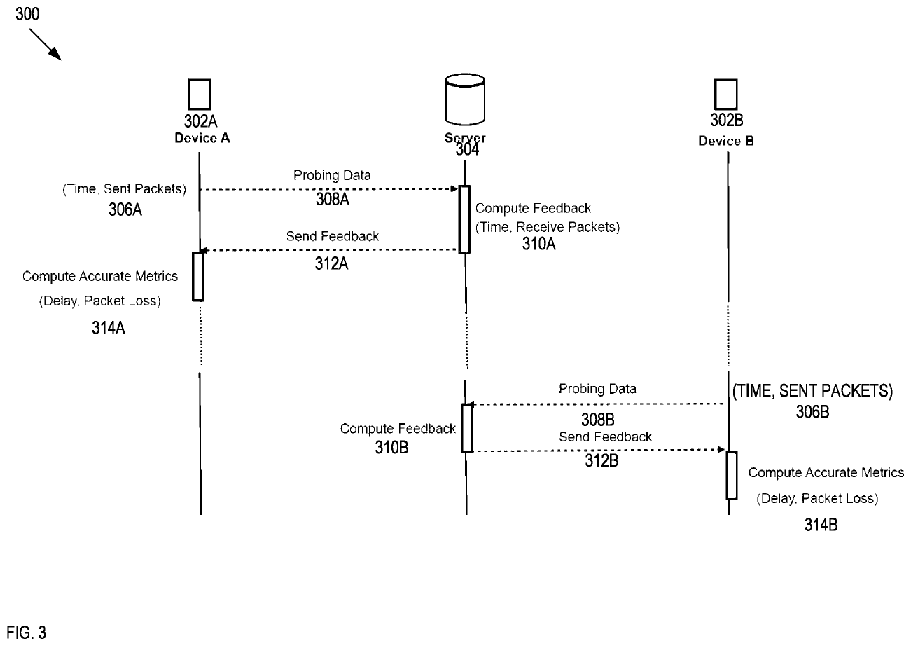

FIG. 3 is an illustration of one embodiment of a system 300 of devices collecting statistics with a server. In FIG. 3, the system 300 includes devices A & B (302A-B), each coupled to the server 304. In one embodiment, device A (302A) sends probing data (308A) to the server. In this embodiment, the probing data can include the time and sent packets. While in one embodiment, the probing is a custom type of packet, in other embodiments, the probing can be one or more standard type packets (e.g., ping packets, and/or other types of standard network probing data). In addition, device A (302A) records the time and the packets sent (306A). The server computes the feedback (310A) from the probing data (e.g., the time of the received packets) and sends the feedback (310A) to device A (302A). The device A (302A) receives the feedback and computes the accurate metrics (314A). In one embodiment, the accurate metrics can include packet delay, packet loss, round trip time, retransmission fulfillment ratio, on-time fulfillment ratio and/or other metrics. In addition, device B can gather accurate metrics with the server as well. In one embodiment, device B (302B) sends probing data (308B) to the server. In this embodiment, the probing data can include the time and sent packets. In addition, device B (302B) records the time and the packets sent (306B). The server computes the feedback (310B) from the probing data (e.g., the time of the received packets) and sends the feedback (310B) to device B (302B). The device B (302B) receives the feedback and commutes the accurate metrics (314B). In one embodiment, the accurate metrics can include packet delay, packet loss, round trip time, and/or other metrics.

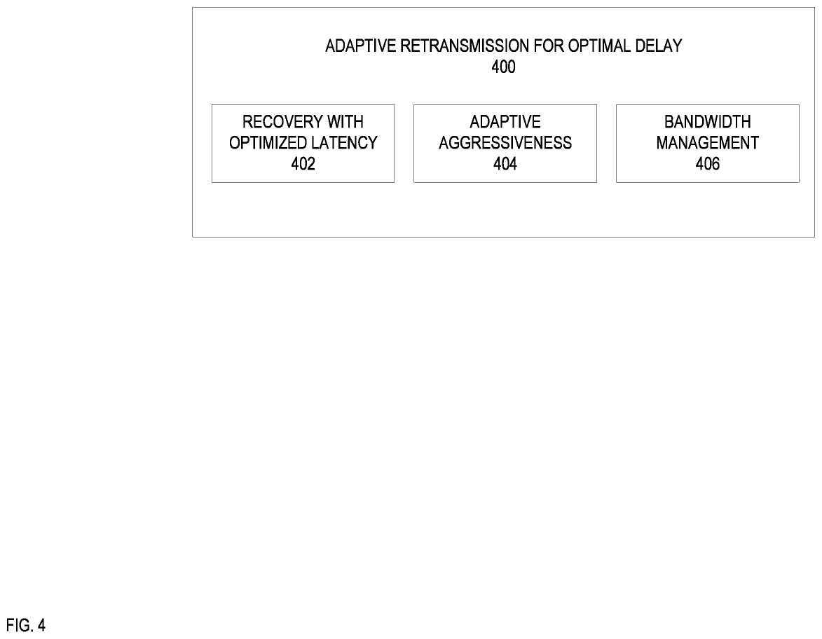

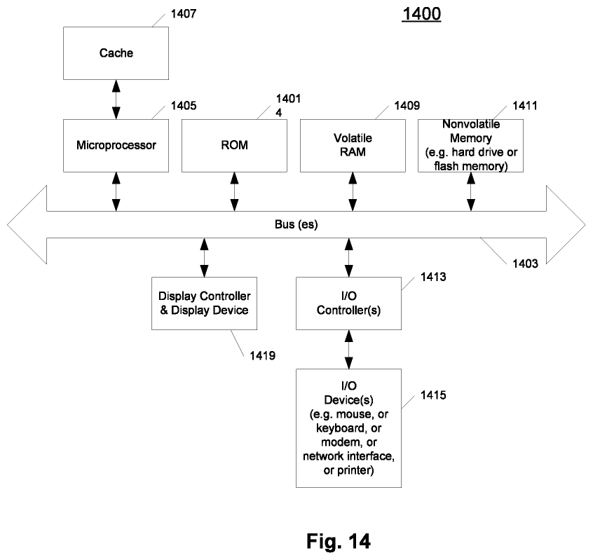

As per above, the length it takes for a lost packet to be retransmitted and received can affect the amount of time the video stream playback is disrupted. FIG. 4 is an illustration of one embodiment of a process 400 for adaptive retransmission for optimal delay. In FIG. 4, process 400 include sub-processes for recovery with optimized latency 402, adaptive aggressiveness 404, and bandwidth management 406. In one embodiment, the recovery with optimized latency 402 determines stores late packets in an incomplete frame buffer instead of just dropping those packets. The adaptive aggressiveness 404 determines an adaptive aggressiveness for when to request retransmission and is further described in FIGS. 11-13. The bandwidth management 406 determines if there is enough bandwidth available to be able to request the retransmission and is further described in FIG. 14.

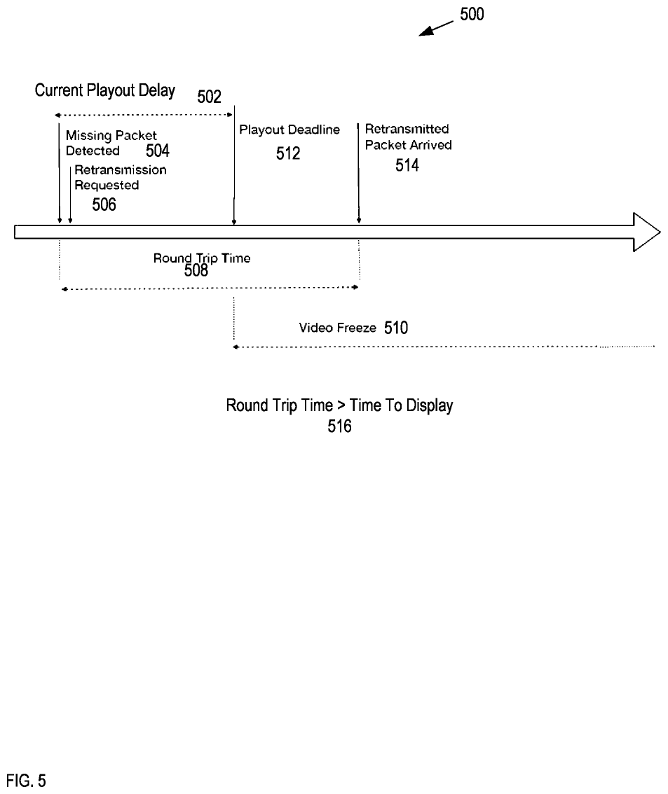

FIG. 5 is an illustration of one embodiment of a missing packet timeline 500 leading to video freeze as known in the art. In FIG. 5, the missing packet timeline 500 starts with a missing packet detected (504). Retransmission of the packet is requested (506) and there is a current playout delay (502) In one embodiment, the current playout delay (502) is defined in order to track network jitter. After the current playout delay (502), there is a playout deadline (512). Overlapping with the playout deadline (512) is the round trip time (508), which represents the time it takes for a packet to be requested for retransmission and for the requested packet to arrive at the receiving device. At 514, the retransmitted packet arrives, where the video stream playout can resume. However, the video stream playout freeze continues past when the retransmitted packet arrived (514).

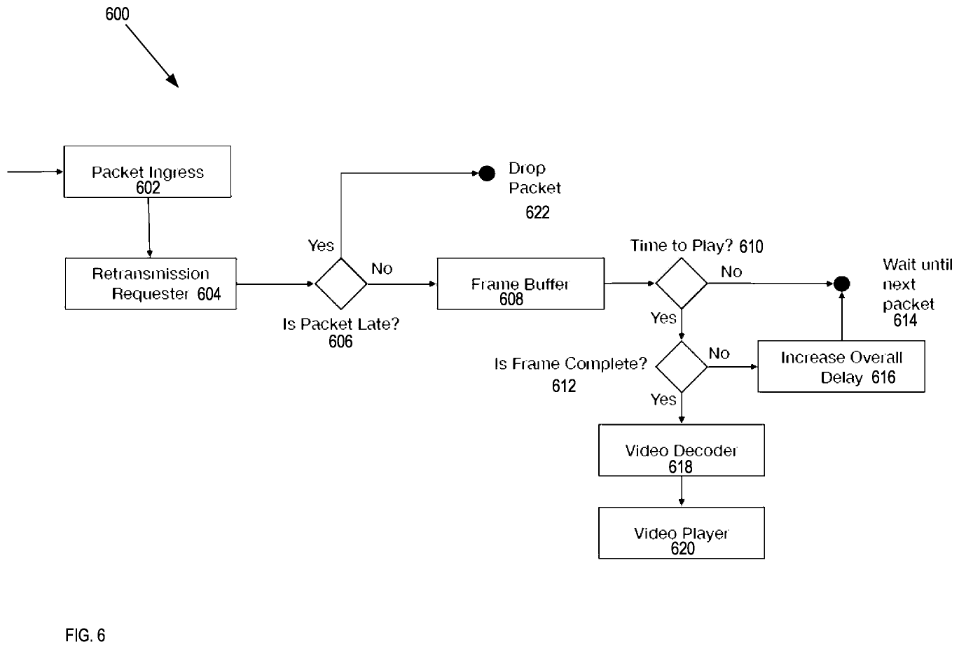

FIG. 6 is a flow diagram of one embodiment of a process that manages packet retransmission for a video stream. In FIG. 6, process 600 begins by ingesting packets at block 602. In one embodiment, process 600 receives a series of packets for a video stream. If a packet is late or lost, process 600 requests retransmission at block 604. In one embodiment, process 600 sends the retransmission to the server, where the server caches packets for the video stream. At block 606, process 600 determines if the packet is late. In this embodiment, a late packet is a packet that arrives after playout deadline, where the playout deadline is determined by one or more factors. In one embodiment, a playout deadline is a time at which a frame is expected to be played. In one embodiment, the packet can be an original packet or a retransmitted packet. If the packet is late, process 600 drops the packet at block 622. In one embodiment, because process 600 drops the late packet means that the frame that utilizes this packet will be decoded or played, thus causing a video freeze that needs to be repaired. If the packet is not late, at block 608, process 600 stores the packet in a frame buffer. At block 610, process 600 determines if it is time to play the video stream. In one embodiment, process 600 determines if time to play based on the frame(s) in the buffer. If not, process 600 wait until the next packet arrives in the frame buffer at block 614. At block 616, process 600 increases the overall delay for playing out the frames in the frame buffer. If, at block 610, process 600 determines that if it is time to play, process determines if the frame is complete at block 612. In one embodiment, a complete frame is a frame where either the packets for the frame have arrived and/or any missing packets were reconstructed (e.g., Forward Error Correction or another way to reconstruct a packet). If not, process 600 increases the overall delay for playing out the frames in the frame buffer at bock 616. If, at block 612, process 600 determines that the frame is complete, process 600 decodes the frame at block 618 and plays out the frame at block 620.

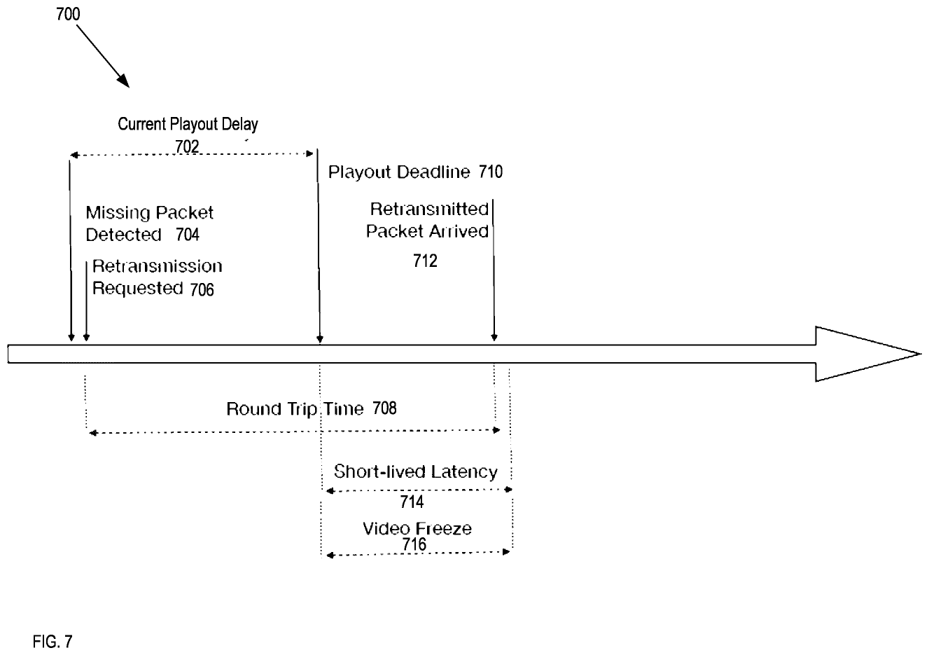

FIG. 7 is an illustration of one embodiment of a missing packet timeline 700 leading to a shortened video freeze. In FIG. 7, the missing packet timeline 700 starts with a missing packet detected (704). Retransmission of the packet is requested (706) and there is a current playout delay (702). After the current playout delay (702), there is a playout deadline (710). Overlapping with the playout deadline (710) is the round trip time (708), which represents the time it takes for a packet to be requested for retransmission and for the requested packet to arrive at the receiving device. The requested packet arrives (712) after the round trip time (708). In contrast with FIG. 5, there is a smaller short-lived latency (714) than in FIG. 5 for a video freeze (716).

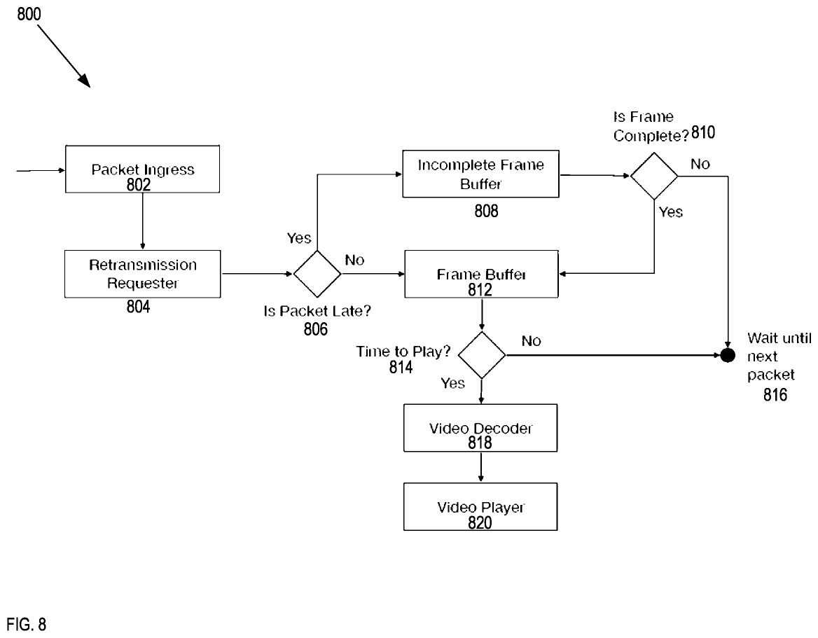

FIG. 8 is a flow diagram of one embodiment of a process 800 that manages packet retransmission for a video stream and reduces the video freeze. In FIG. 8, process 800 begins by ingesting packets at block 802. In one embodiment, process 800 receives a series of packets for a video stream. If a packet is late or lost, process 800 requests retransmission at block 804. In one embodiment, process 800 sends the retransmission to the server, where the server caches packets for the video stream. At block 806, process 800 determines if the packet is late. If the packet is late, instead of dropping the packet (as in FIG. 6), process 800 stores the packet in an incomplete frame buffer at block 808. Process 800 determines if the frame in the incomplete buffer is complete at block 810. If the frame in the complete buffer is complete, the completed frame is copied over to the frame buffer at block 812. If the frame is not complete in the incomplete frame buffer, process 800 waits until the next packet arrives at block 816. Process 800 determines that if it is time to play at block 814. In one embodiment, process 800 determines if it is time to play by process 800 determining when the frame timestamp meets the playout deadline. Playout deadline as explained above is set to track network jitter. If not, process 800 waits until the next packet arrives at block 816. If, at block 814, process 800 determines that it is time to play, process 800 decodes the frame at block 818 and plays out the frame at block 820.

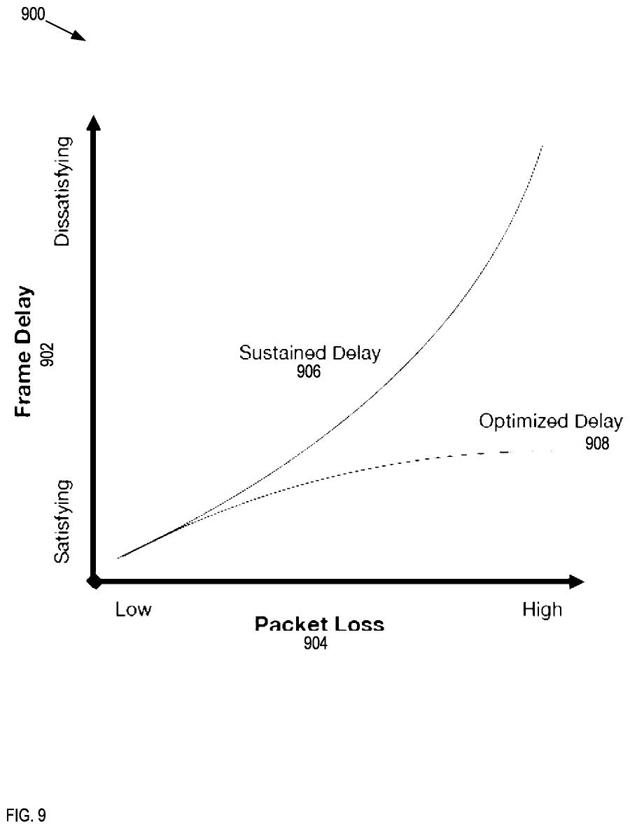

FIG. 9 is an illustration of one embodiment of a plot 900 of a frame delay for a sustained delay versus an optimized delay. In FIG. 9, the plot is of frame delay 902 time on the y-axis from satisfying to dissatisfying. In one embodiment, a dissatisfying time is 400-500 ms of greater. With this time, a viewer of the video stream can show discomfort in viewing the video stream. Alternatively, frame delays of up to 200 ms is found to be acceptable. The sustained delay (as illustrated in FIG. 6) increases as the packet loss 904 goes from a low packet low to a high packet loss. In contrast, with an optimized delay 908 (as illustrated in FIG. 8), a packet loss from low to high is better handled in terms of frame delay going from satisfying to dissatisfying. In one embodiment, a low packet loss is approximately 10%.

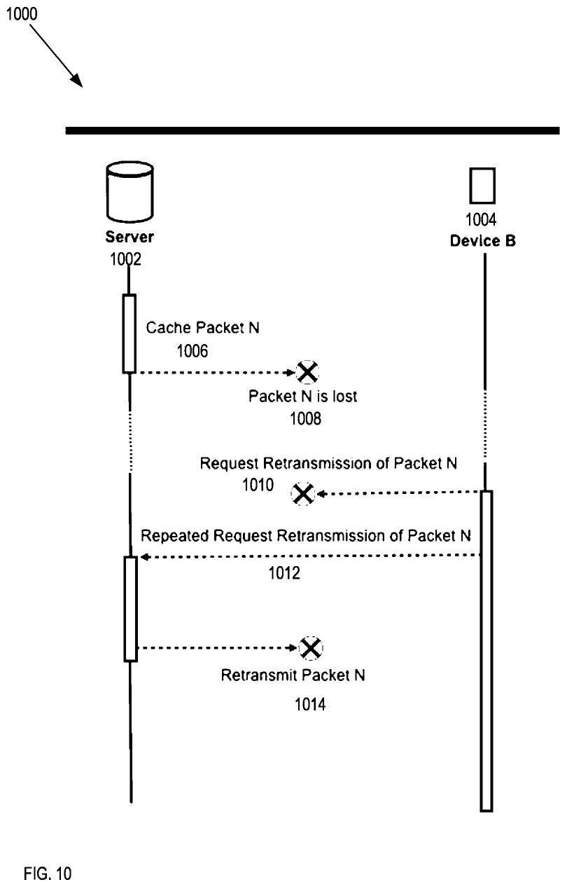

In one embodiment, it is possible that a packet in a video stream is lost multiple times, especially if transmitted over a network experiencing high loss of packets. FIG. 10 is an illustration of one embodiment of a system 1000 of multiple retransmissions of a lost packet. In FIG. 10, the system includes a server 1002 coupled to a device 1004 over a network (not illustrated). The server 1002 caches packet N (1006) and transmits this packets, where packet N is lost (1008). The device 1004 requests a retransmission of packet N (1010), where this retransmission packet is lost (1010). Device 1004 repeats a request retransmission of packet N (1012), where the server 1002 retrieves packet N and retransmits packet N (1014). However, packet N is subsequently lost in the network. Thus FIG. 10 illustrates both that packet N can be lost in the network multiple times and that it is possible that the retransmission request can be lost as well.

In addition, the video playing device (e.g., device 102A-B in FIG. 1 above) can determine how aggressive a video stream receiving device request a packet retransmission. If the receiving device is too aggressive in requesting a retransmission of a lost packet, there may be unnecessary overhead added to the network. Alternatively, if the aggressiveness is too low, a video freeze is unnecessarily lengthened. In one embodiment, determining an aggressiveness factor for requesting retransmission can be computed using the gathered statistics about the network. FIG. 11 is a flow diagram of one embodiment of a process 1100 that determines an aggressiveness factor for packet retransmission. In FIG. 11, process 1100 begins by determining that a packet of a video stream is missing at block 1102. In one embodiment, each of the packets in the video stream have a monotonically increasing sequence number. Whenever there is a gap in the sequence number of incoming packets, process 1100 declares that this packet in that missing sequence of numbers as missing. At block 1104, process 1100 determines if a request from the missing packet been already sent. In one embodiment, process 1100 keeps track of some or all of the retransmission requests. For example, and in one embodiment, process 1100 keeps track of recent retransmission requests. If a retransmission request has not been sent for the packet, process 1100 requests retransmission at block 1118.

If the retransmission request has been sent for the packet, process 1100 checks the time since last request at block 1106. The time since last request is used later for determine whether to request another retransmission for this packet. At block 1108, process 1100 checks the network conditions. In one embodiment, process 1100 retrieves network statistics 1110 (e.g., round trip time, packet loss level, fulfillment ratio, and/or other network statistics) to check network conditions. Process 1100 determines an aggressiveness factor at block 1112. In one embodiment, there are a collection of tiers, where the tiers are defined by the probability of a retransmission to be successful. The probability of success is derived from the current packet loss level and the current fulfillment ratio. In this embodiment, different levels of probability of correspond to different levels of aggressiveness factor. An aggressiveness factor is a portion of the round trip time we need to wait before requesting again a retransmitted packet.

For example, and in one embodiment, a 99% or more of probability of success means that process 1100 can wait for a full round trip time before requesting again for a packet. But a smaller probability value (e.g., 95%) could mean that that process 1100 might request retransmissions every half round trip time or even more. At block 1114, process 1100 determines if the time since last request is greater than the aggressiveness factor. If not, no action is taken at block 1116. If the time since last request is greater than the aggressiveness factor, process 1100 requests retransmission at block 1118.

FIG. 12 is an illustration of one embodiment of a plot 1200 of a time to repeat request versus packet loss for an adaptive aggressiveness and a fixed aggressiveness. In FIG. 12, the plot 1200 plots time to repeat requests 1202 versus packet loss 1204. For a fixed aggressiveness 1208, the time to repeat requests is constant regardless of packet loss. In contrast, the adaptive aggressiveness 1206, the time to repeat requests are higher for a low packet loss network condition, but as the packet loss in the network increases, the adaptive aggressiveness 1206 curve decreases and is less than the fixed aggressiveness for higher packet loss network conditions. Thus, in low packet loss conditions, the aggressiveness factor is more conservative, while in higher packet loss conditions, the aggressiveness factor is more aggressive.

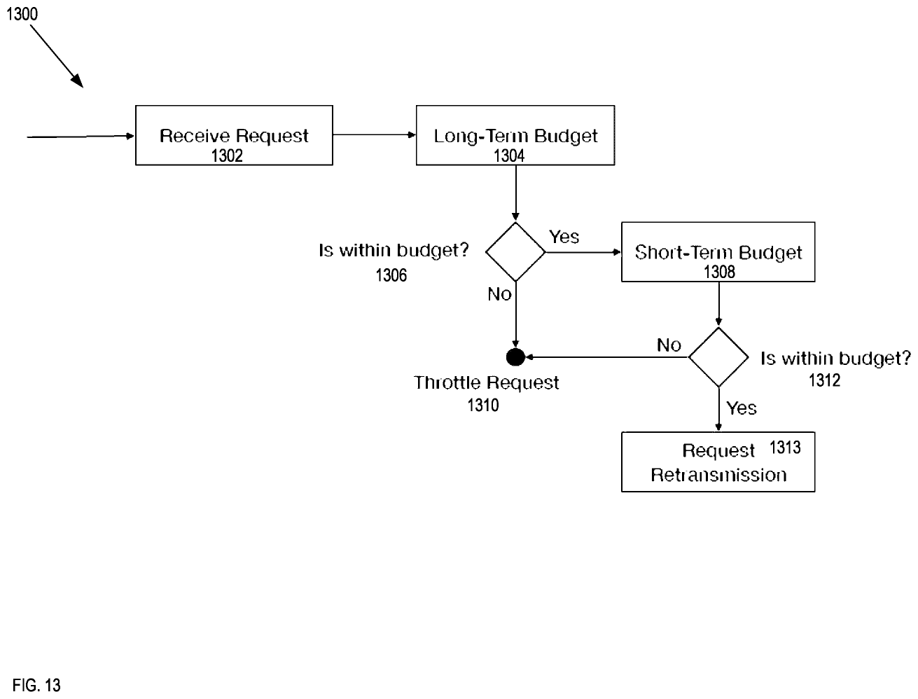

In one embodiment, excessive number of retransmission requests can introduce overhead into the network. FIG. 13 is a flow diagram of one embodiment of a process that determines whether a retransmission request can be sent. In FIG. 13, process 1300 receives a request for retransmission of a packet at block 1302. At block 1304, process 1300 determines a long term budget for retransmission requests. In one embodiment, there are certain amount of retransmission requests that can be within the long term budget. In this embodiment, the long term budge could be a number of allowed retransmission request in a longer time period (e.g., 1 second or another time period). Process 1300 check to see if the retransmission request is within the long term budget at block 1308. If not, process 1300 throttles the request at block 1310. In one embodiment, process 1300 can throttle the retransmission request by delaying the request for a certain time period. If the retransmission request is within the long term budget, process 1300 determines a short-term budget at block 1308. In one embodiment, there are certain amount of retransmission requests that can be within the short-term budget. In this embodiment, the short-term budget could be a number of allowed retransmission request in a shorter time period (e.g., 100 second or another time period that is smaller than the long-term period). Process 1300 check to see if the retransmission request is within the short-term budget at block 1312. If not, process 1300 throttles the request at block 1310. If retransmission request is within the short-term budget, process 1300 requests the retransmission at block 1314.

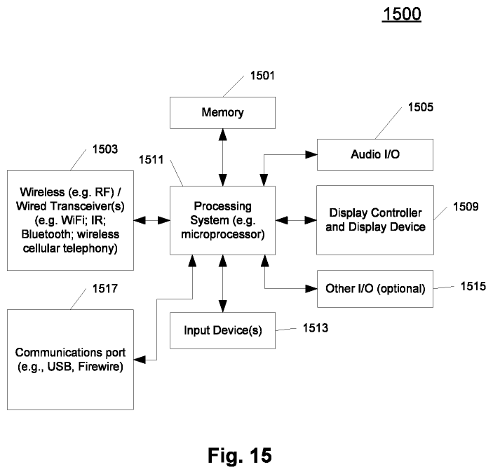

FIG. 14 shows one example of a data processing system 1400, which may be used with one embodiment of the present invention. For example, the system 1400 may be implemented as a system that includes device 102A-B as illustrated in FIG. 1 above. Note that while FIG. 15 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 14, the computer system 1400, which is a form of a data processing system, includes a bus 1403 which is coupled to a microprocessor(s) 1405 and a ROM (Read Only Memory) 1401 and volatile RAM 1409 and a non-volatile memory 1411. The microprocessor 1405 may include one or more CPU(s), GPU(s), a specialized processor, and/or a combination thereof. The microprocessor 1405 may retrieve the instructions from the memories 1407, 1409, 1411 and execute the instructions to perform operations described above. The bus 1403 interconnects these various components together and also interconnects these components 1405, 1407, 1409, and 1411 to a display controller and display device 1419 and to peripheral devices such as input/output (I/O) devices which may be mice, keyboards, modems, network interfaces, printers and other devices which are well known in the art. Typically, the input/output devices 1415 are coupled to the system through input/output controllers 1413. The volatile RAM (Random Access Memory) 1409 is typically implemented as dynamic RAM (DRAM), which requires power continually in order to refresh or maintain the data in the memory.

The mass storage 1415 is typically a magnetic hard drive or a magnetic optical drive or an optical drive or a DVD RAM or a flash memory or other types of memory systems, which maintain data (e.g. large amounts of data) even after power is removed from the system. Typically, the mass storage 1415 will also be a random access memory although this is not required. While FIG. 14 shows that the mass storage 1415 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 1403 may include one or more buses connected to each other through various bridges, controllers and/or adapters as is well known in the art.

FIG. 15 shows an example of another data processing system 1500 which may be used with one embodiment of the present invention. For example, system 1500 may be implemented as device 102A-B as shown in FIG. 1 above. The data processing system 1500 shown in FIG. 15 includes a processing system 1511, which may be one or more microprocessors, or which may be a system on a chip integrated circuit, and the system also includes memory 1501 for storing data and programs for execution by the processing system. The system 1500 also includes an audio input/output subsystem 1505, which may include a microphone and a speaker for, for example, playing back music or providing telephone functionality through the speaker and microphone.

A display controller and display device 1509 provide a visual user interface for the user; this digital interface may include a graphical user interface which is similar to that shown on a Macintosh computer when running OS X operating system software, or Apple iPhone when running the iOS operating system, etc. The system 1500 also includes one or more wireless transceivers 1503 to communicate with another data processing system, such as the system 1500 of FIG. 15. A wireless transceiver may be a WLAN transceiver, an infrared transceiver, a Bluetooth transceiver, and/or a wireless cellular telephony transceiver. It will be appreciated that additional components, not shown, may also be part of the system 1500 in certain embodiments, and in certain embodiments fewer components than shown in FIG. 15 may also be used in a data processing system. The system 1500 further includes one or more communications ports 1517 to communicate with another data processing system, such as the system 1500 of FIG. 15. The communications port may be a USB port, Firewire port, Bluetooth interface, etc.

The data processing system 1500 also includes one or more input devices 1513, which are provided to allow a user to provide input to the system. These input devices may be a keypad or a keyboard or a touch panel or a multi touch panel. The data processing system 1500 also includes an optional input/output device 1515 which may be a connector for a dock. It will be appreciated that one or more buses, not shown, may be used to interconnect the various components as is well known in the art. The data processing system shown in FIG. 15 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device or an embedded device or other consumer electronic devices. In other embodiments, the data processing system 1500 may be a network computer or an embedded processing device within another device, or other types of data processing systems, which have fewer components or perhaps more components than that shown in FIG. 15.

At least certain embodiments of the inventions may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on an iPod® or iPod Nano® media player from Apple, Inc. of Cupertino, CA, a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s). Examples of a portable media player are described in published U.S. Pat. No. 7,345,671 and U.S. published patent number 2004/0224638, both of which are incorporated herein by reference.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “storing,” “forwarding,” “communicating,” “sending,” “loading,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A non-transitory machine-readable medium having executable instructions to cause one or more processing units to perform a method to manage a video stream, the method comprising:
receiving, with a video playout device, a plurality of packets for a video stream from a transmitting device via a server;
storing a first packet of the plurality of packets in a first buffer when the first packet is on-time;
storing a second packet of the plurality of packets in a second buffer when the second packet is late; and
forwarding a frame from the second buffer to the first buffer when frame is complete.

2. The non-transitory machine-readable medium of claim 1, further comprising:
requesting a retransmission of the second packet.

3. The non-transitory machine-readable medium of claim 2, wherein the second packet is cached at the server.

4. The non-transitory machine-readable medium of claim 2, wherein the second packet is cached in the server and the retransmission request is sent to the server.

5. The non-transitory machine-readable medium of claim 1, further comprising:
determining if a packet of the plurality of packets is late.

6. The non-transitory machine-readable medium of claim 5, wherein the packet is late when that packet arrives after a corresponding playout deadline.

7. The non-transitory machine-readable medium of claim 1, wherein a complete frame is where packets for this frame have arrived or have been reconstructed.

8. The non-transitory machine-readable medium of claim 1, further comprising:
determining that the complete frame is ready to be played;
decoding the complete frame; and
playing the frame.

9. A non-transitory machine-readable medium having executable instructions to cause one or more processing units to perform a method to determine when to request of a retransmission of missing packet, the method comprising:
determining that the packet of a plurality of packets in a video stream is missing; determine an aggressiveness factor for requesting a retransmission of the missing packet, the aggressiveness factor determined using a network statistic;
requesting a retransmission of the missing packet using a comparison of a time since last retransmission request and the aggressiveness factor.

10. The non-transitory machine-readable medium of claim 9, wherein the packet of the plurality of packets is declared missing when there is a gap in a sequence number of incoming packets.

11. The non-transitory machine-readable medium of claim 9, further comprising:
determining that a request retransmission has been previously requested; and
requesting a transmission packet when has not been sent.

12. The non-transitory machine-readable medium of claim 11, further comprising:
keeping track of previous sent retransmission requests.

13. The non-transitory machine-readable medium of claim 9, wherein the aggressiveness factor is portion of a round-trip time before requesting a retransmission of the missing packet.

14. The non-transitory machine-readable medium of claim 9, further comprising:
sending the retransmission request when the is room in a budget to send the retransmission request.

15. The non-transitory machine-readable medium of claim 14, wherein the budget includes a short term budget and a long term budget.

16. A method to manage a video stream, the method comprising:
receiving, with a video playout device, a plurality of packets for a video stream from a transmitting device via a server;
storing a first packet of the plurality of packets in a first buffer when the first packet is on-time;
storing a second packet of the plurality of packets in a second buffer when the second packet is late; and
forwarding a frame from the second buffer to the first buffer when frame is complete.

17. The method of claim 16, further comprising:
requesting a retransmission of the second packet.

18. The method of claim 17, wherein the second packet is cached at the server.

19. The method of claim 17, wherein the second packet is cached in the server and the retransmission request is sent to the server.

20. A method to determine when to request of a retransmission of missing packet, the method comprising:
determining that the packet of a plurality of packets in a video stream is missing;
determine an aggressiveness factor for requesting a retransmission of the missing packet, the aggressiveness factor determined using a network statistic;
requesting a retransmission of the missing packet using a comparison of a time since last retransmission request and the aggressiveness factor.
